(19) United States
(12) Patent Application Publication
(10) Pub. No.: US 2013/0198633 A1
(43) Pub. Date: Aug. 1, 2013

(54) LOCATION-BASED MUSIC TAGGING AND SHARING THROUGH A MUSIC SERVICE

(71) Applicant: David Hyman, Kensington, CA (US)

(72) Inventor: David Hyman, Kensington, CA (US)

(21) Appl. No.: 13/754,669

(22) Filed: Jan. 30, 2013

Related U.S. Application Data
(60) Provisional application No. 61/592,011, filed on Jan. 30, 2012.

(51) Int. Cl. G06F 3/01

(52) U.S. Cl. CPC G06F 3/01
USPC 715/716

(57) ABSTRACT

A method includes providing, through a music server communicatively coupled to a music device, a capability to a user of the music device to tag a song. The method also includes associating, through the music server, a location of the music device with the song based on the tagging. Further, the method includes solely providing, through the music server, access to the tagged song to the user and/or another user when the corresponding music device of the user and/or another music device associated with the another user is within the location.

### CLAIM OF PRIORITY

This non-provisional application is a conversion application and claims priority from U.S. Provisional Patent Application No. 61/592,011 titled LOCATION BASED MUSIC TAGGING AND SHARING filed on Jan. 30, 2012.

### FIELD OF TECHNOLOGY

This disclosure relates generally to music service(s) and, more particularly, to location-based music tagging and sharing through a music service.

### BACKGROUND

A user (e.g., a music fan) may listen to music through a radio station, a subscription service (e.g., Napster®, Rhapsody®) and/or a streaming music service (e.g., Pandora®). The user may also purchase music through a music service (e.g., Apple® iTunes). The user may possess a capability to listen to music in a number of locations through a portable music player (e.g., Apple® iPod®) and/or a car stereo.

The user may develop an emotional connection with music and associate certain songs with a particular place (e.g., a high school of enrolment thereof). One or more songs may remind the user of a particular place or, vice versa, the particular place may remind the user of the one or more songs. The user may want to listen to music associated with the particular place during a visit thereto for nostalgic purposes and/or share the music associated with the particular place with connections (e.g., family, friends, fans) thereof.

### SUMMARY

Disclosed are a method, a device and/or a system of location-based music tagging and sharing through a music service.

In one aspect, a method includes providing, through a music server communicatively coupled to a music device, a capability to a user of the music device to tag a song. The method also includes associating, through the music server, a location of the music device with the song based on the tagging. Further, the method includes solely providing, through the music server, access to the tagged song to the user and/or another user when the corresponding music device of the user and/or another music device associated with the another user is within the location.

In another aspect, a music server includes a memory, and a processor communicatively coupled to the memory. The processor is configured to execute instructions to provide a capability to a user of a music device to tag a song accessed from a database via the music server. The processor is also configured to execute instructions to associate a location of the music device with the song based on the tagging. Further, the processor is configured to execute instructions to solely provide access to the tagged song to the user and/or another user when the corresponding music device of the user and/or another music device associated with the another user is within the location.

In yet another aspect, a system includes a music device, and a music server communicatively coupled to the music device. The music server is configured to provide a capability to a user of the music device to tag a song and to associate a location of the music device with the song based on the tagging. Further, the music server is configured to solely provide access to the tagged song to the user and/or another user when the corresponding music device of the user and/or another music device associated with the another user is within the location.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1A is a schematic view of a music tagging system, according to one embodiment.

FIG. 1B is a schematic view of the music tagging system of FIG. 1A having another user therein, according to one embodiment.

FIG. 2 is a schematic view of a tagging module of a music server of the music tagging system of FIG. 1A, according to one embodiment.

FIG. 3 is a schematic view of a user interface of a music device of the music tagging system of FIG. 1A, according to one embodiment.

FIG. 4 is a process flow diagram detailing the operations involved in location-based music tagging and sharing through a music service, according to one embodiment.

Other features of the present embodiments will be apparent from the accompanying drawings and from the detailed description that follows.

### DETAILED DESCRIPTION

Example embodiments, as described below, may be used to provide a method, a device and/or a system of location-based music tagging and sharing through a music service. Although the embodiments have been described with reference to specific example embodiments, it will be evident that various modifications and changes may be made to these embodiments without departing from the broader spirit and scope of the various embodiments.

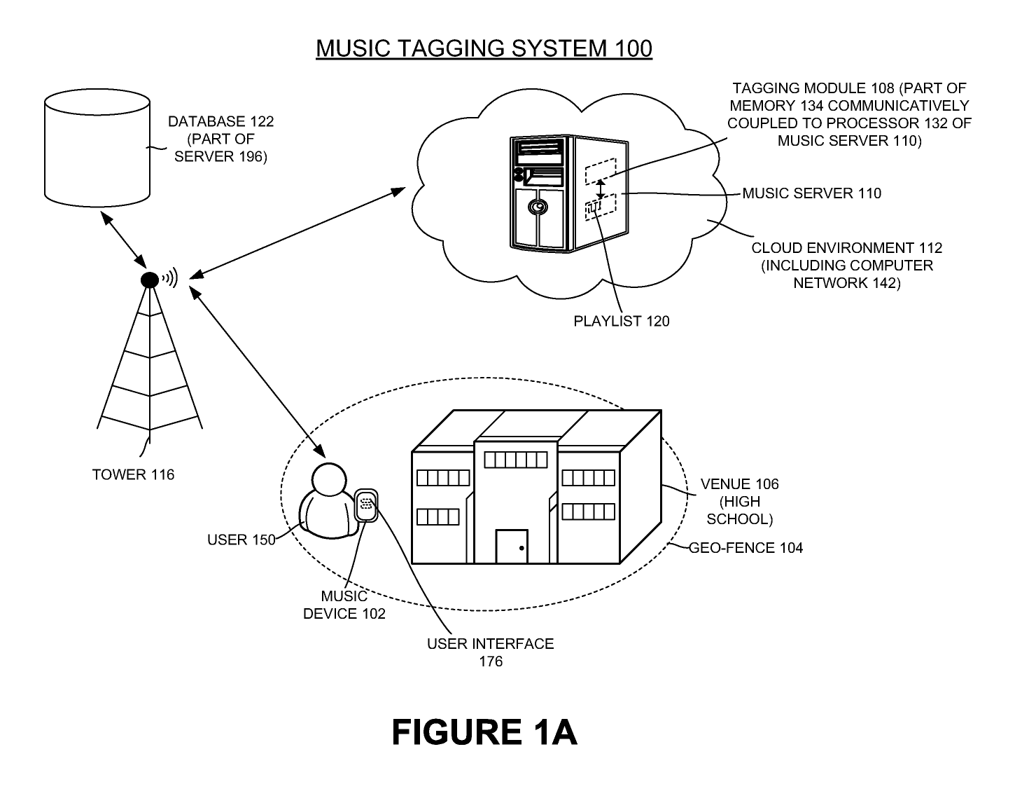

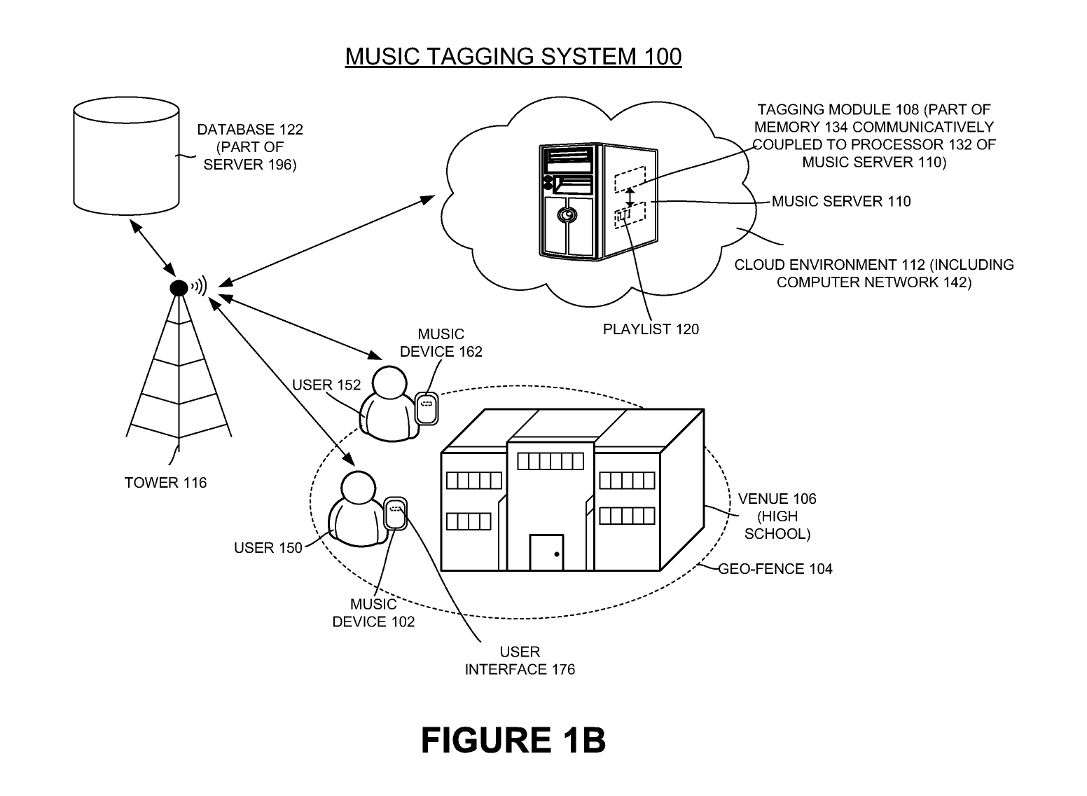

FIG. 1A shows a music tagging system 100, according to one embodiment. In one or more embodiments, music tagging system 100 may include a music device 102 (e.g., a desktop computer, a laptop computer, a notebook computer, a netbook, a mobile device such as a mobile phone) communicatively coupled to a music server 110 through a computer network 142 (e.g., shown as part of a cloud environment 112). In one or more embodiments, computer network 142 may be a Local Area Network (LAN), a Wide Area Network (WAN), Internet, a satellite communication network etc. When a user 150 of music device 102 is at a venue 106 within a geo-fence 104 associated therewith, user 150 may be provided a capability to tag music (e.g., songs) related to venue 106, as will be discussed below.

In one or more embodiments, venue 106 may be a geographic location and/or a position (or, a point) in physical space on the surface of the Earth. In the illustrative example of FIG. 1A, venue 106 is a high school. Geo-fence 104 may be a virtual perimeter of venue 106 (e.g., high school). In one or more embodiments, geo-fence 104 may be dynamically generated as a radius around venue 106 through an appropriate capability of music device 102 and/or music server 110. In the high school example of venue 106, geo-fence 104 may be a predefined set of boundaries such as school attendance zones and/or or neighborhood boundaries. In one example embodiment, music device 102 may be a location-aware device such that when music device 102 enters geo-fence 104, certain capabilities thereof are activated. For example, when music device 102 enters geo-fence 104 associated with venue 106, user 150 of music device 102 may be provided a capability to tag and/or access playlists or music associated with venue 106. When user 150 exits geo-fence 104, the aforementioned capability may be disabled.

In the illustrative example of FIG. 1A, computer network 142 may include a tower 116 configured to relay signals between music device 102 and music server 110. Cloud environment 112 may provide software, data access and/or storage services to music device 102 such that user 150 is unaware of the physical location and/or configuration of the system delivering said services. In one or more embodiments, music server 110 may execute a tagging module 108 (e.g., on a processor 132 communicatively coupled to a memory 134; tagging module 108 (a set of instructions) is shown as being stored in memory 134) configured to permit user 150 to create a playlist 120 of music (e.g., songs) associated with venue 106 such that playlist 120 is accessible when music device 102 is within geo-fence 104.

In one or more embodiments, tagging module 108 may also permit user 150 to share the tagged music with another user (e.g., user 152 of FIG. 1B associated with another music device 162) within the geo-fence 104. In one or more embodiments, tagging module 108 may determine a location of music device 102 (and/or another music device 162) based on a global positioning system (GPS)-capability (geospatial locational capability in general) thereof. In another example, the location of music device 102 (and/or another music device 162) may be determined based on a triangulation calculation utilizing at least three towers (e.g., including tower 116).

In one or more embodiments, user 150 of music device 102 may create playlist 120 through a user interface 176 therefor on music device 102; music device 102 may execute an appropriate module to enable creation of playlist 120. In one or more embodiments, during the creation of playlist 120, a database 122 including a repository of music (e.g., songs and metadata associated therewith) may be accessed through music device 102. In one or more embodiments, database 122 may be associated with music server 110; in one example embodiment, database 122 may reside on a separate server (e.g., server 196) communicatively coupled to music server 110 through computer network 142. In one or more embodiments, user 150 may select and/or aggregate one or more songs to create playlist 120.

In one or more embodiments, during tagging of playlist 120 through music device 102, an association between venue 106 and playlist 120 (or, one or more songs thereof) may be created. In one or more embodiments, as discussed above, user 150 may share the music tagged with another user 152 through setting a preference and/or a privacy control in music device 102; another user 152 may obtain access thereto when music device 162 is within geo-fence 104.

It is to be noted that the location-based tagged music may be accessed at a time later than that of the tagging. For example, user 150 may access playlist 120 (music, or, songs) associated with venue 106 when user 150 returns thereto at a later time. User 150 may have tagged music with reference to a high school thereof (e.g., music that user 150 listened to during a time of enrolment thereof). At a later point in time, user 150 may return to the high school (e.g., for a reunion) and access the tagged music. Thus, exemplary embodiments provide for a nostalgic experience to user 150. In another example, user 150 may share the tagged music with his/her children. When children of user 150 attend the same high school or visit the aforementioned high school, the tagged music may be heard (e.g., when within geo-fence 104).

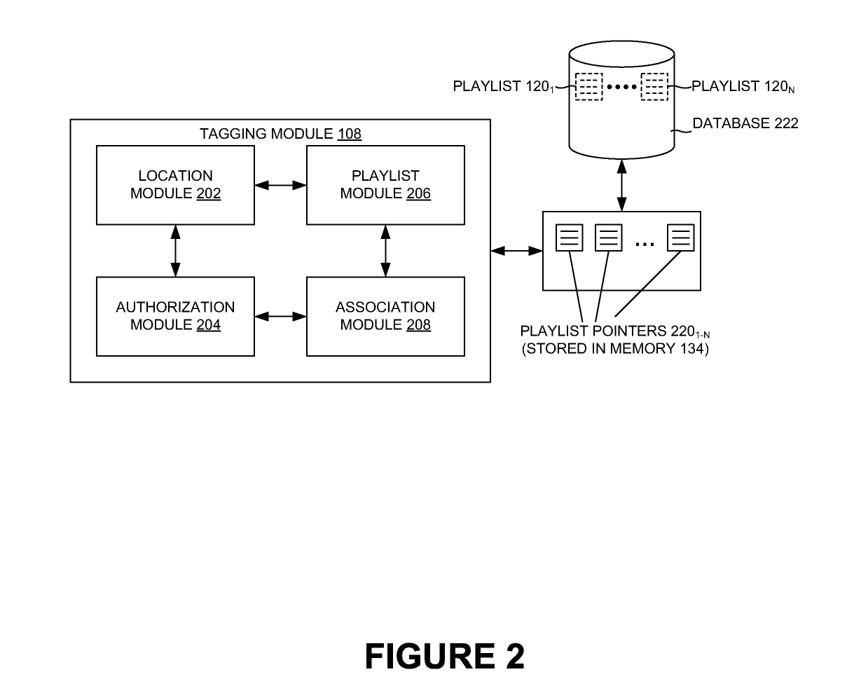

FIG. 2 shows tagging module 108 of music server 110, according to one embodiment. In one or more embodiments, tagging module 108 may include a location module 202, an authorization module 204, a playlist module 206 and an association module 208. In one or more embodiments, tagging module 108 may be configured to communicate with database 222 (e.g., a local database) having stored playlists therein. Location module 202 may determine the present location of music device 102 (e.g., based on a GPS capability of music server 110 and/or music device 102). Authorization module 204 may permit another user 152 access playlist 120 when within geo-fence 104 based on verification of identity thereof. As discussed above, user 150 may grant a privilege and/or adjust a privacy setting such that another user 152 may access playlist 120 when within geo-fence 104. Also, authorization module 204 may restrict access to playlist 120 when music device 102 is outside geo-fence 104.

Playlist module 206 may generate playlist 120 based on a request generated by user 150 through music device 102. Playlist module 206 may retrieve playlist 120 from database 222 such that playlist 120 is available to music device 102 when music device 102 is within geo-fence 104. Association module 208 may create an association between playlist 120 and a location such that playlist 120 is tagged to the location and playlist 120 is accessible when music device 102 is within geo-fence 104. For example, association module 208 may create a timestamp denoting the aforementioned association and tagging. In one or more embodiments, based on playlist pointers 220_{1-N} (e.g., stored in memory 134, along with all other modules), the appropriate playlist 120 may be matched in database 222 and retrieved as and when required.

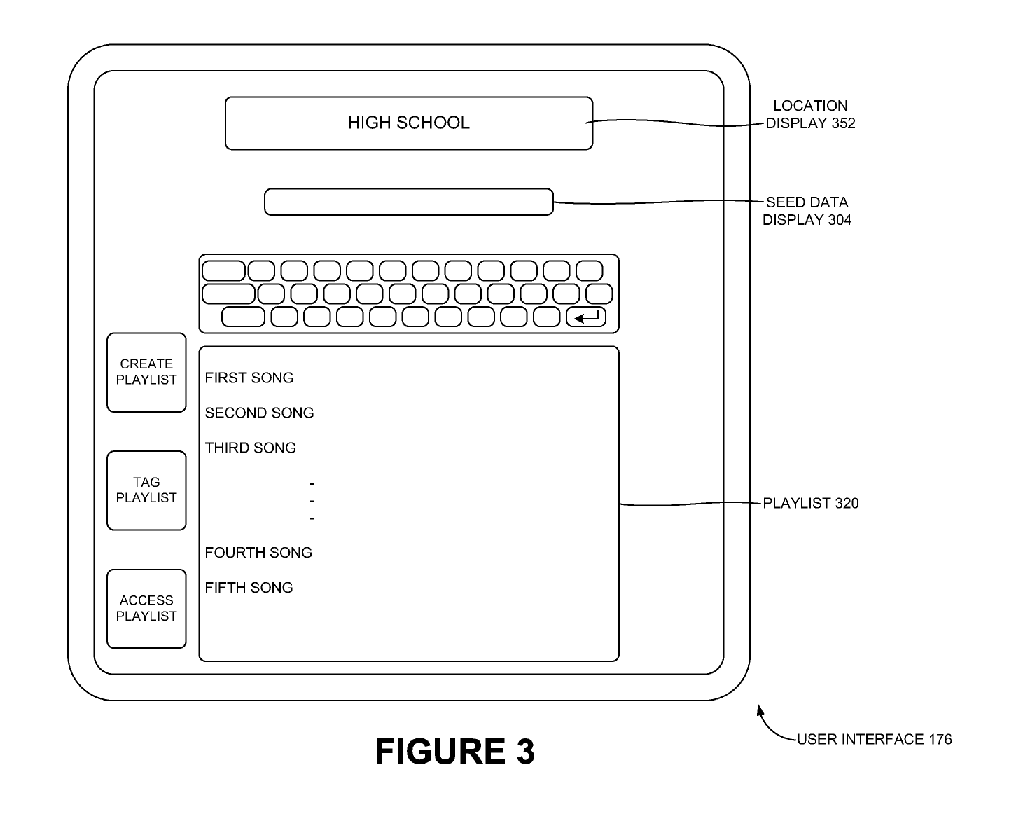

FIG. 3 shows a user interface 176 of music device 102, according to one embodiment. In one or more embodiments, user interface 176 may be used to select and play the songs based on a selection criterion. The songs may be selected based on a seed data provided to user 150, the seed data being driver of creation of playlist 120. The seed data may include a seed artist, a seed album, seed song, etc. The input seed data may be displayed on a seed data display 304. User interface 176 may permit user 150 to create playlist 320 (e.g., analogous to playlist 120). User interface 176 may include a location display 352 to display a present location of music device 102 based on the tagging. For example, when music device 102 is within geo-fence 104 of the high school discussed above, the name of venue 106 may appear in the location display 352 (e.g., shown as “High School” in FIG. 3).

It is to be noted that music interface 176 may provide access to playlists associated with other users (e.g., user 152); similarly, a music interface on music device 162 may provide access to playlists tagged by other users.

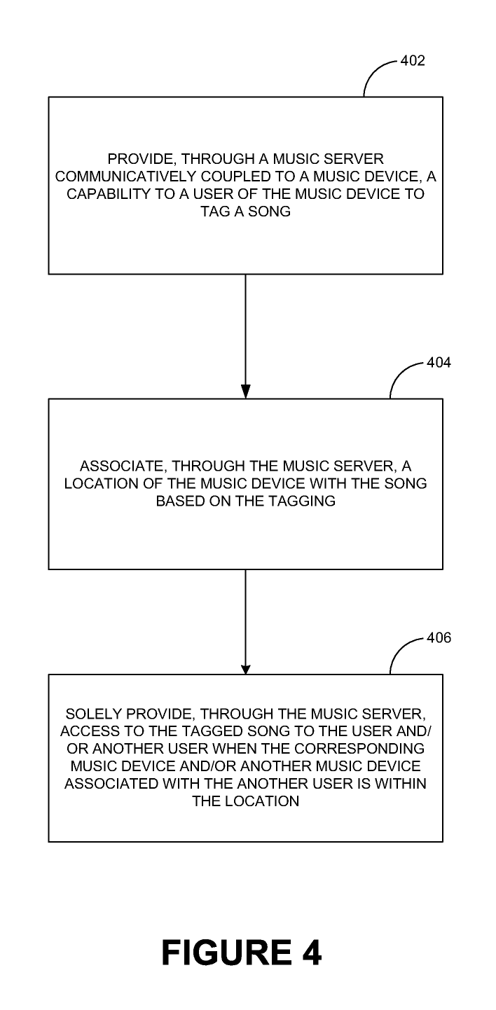

FIG. 4 shows a process flow diagram detailing the operations involved in location-based music tagging and sharing through a music service, according to one or more embodiments. In one or more embodiments, operation 402 may involve providing, through music server 110 communicatively coupled to music device 102, a capability to user 150 to tag a song. In one or more embodiments, operation 404 may involve associating, through music server 110, a location of music device 102 with the song based on the tagging. In one or more embodiments, operation 406 may then involve solely providing, through music server 110, access to the tagged song to user 150 and/or another user 152 when the corresponding music device 102 of user 150 and/or another music device 162 associated with another user 152 is within the location.

An example scenario will now be described to which concepts associated with the exemplary embodiments may be applicable. A music service provider (e.g., “XYZ Music Service”) may be subscribed to by user 150 that enjoys streaming music through music device 102. User 150 may have strong emotional connections to a locational context in which music may be experienced (e.g., a beach, a university, a concert hall, a long-distance drive, a first date). User 150 may choose to generate one or more playlists (e.g., playlist 120) of one or more songs to be listened to in the locational context, and tag the aforementioned one or more playlists. The tagging may enable user 150 to listen to playlist 120 at a later date at a same location of tagging (e.g., “High School” discussed above). The tag may be a username, a playlist name, and/or a timestamp that a database of XYZ Music Service uses to associate playlist 120 with the appropriate location. XYZ Music Service may also enable making playlist 120 available to other subscribed users by recognizing the location of said other subscribed users through music devices thereof and allowing access to a stream of playlist 120.

Another example of XYZ Music Service may involve interaction of famous persons that may be subscribers with regular users through playlist sharing. For example, a famous person may create a playlist (e.g., playlist 120) and choose to share the playlist with fans thereof. In another example, a famous musician may create a playlist of favorite music before a performance at a concert hall. Audience members of the performance may be allowed access to the playlist upon entering a geo-fence surrounding the concert hall at a time before or after the performance.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software or any combination of hardware, firmware, or software (e.g., embodied in a non-transitory machine-readable medium). For example, the various electrical structure and methods may be embodied using transistors, logic gates, and electrical circuits (e.g., application specific integrated (ASIC) circuitry or in Digital Signal Processor (DSP) circuitry).

In addition, it will be appreciated that the various operations, processes, and methods disclosed herein may be embodied in a machine-readable medium or a machine accessible medium compatible with a data processing system (e.g., a computer system), and may be performed in any order (e.g., including using means for achieving the various operations). Accordingly, the specification and the drawings are to be regarded in an illustrative rather than a restrictive sense.

What is claimed is:

1. A method, comprising:
providing, through a music server communicatively coupled to a music device, a capability to a user of the music device to tag a song;
associating, through the music server, a location of the music device with the song based on the tagging; and
solely providing, through the music server, access to the tagged song to at least one of the user and another user when a corresponding at least one of the music device of the user and another music device associated with the another user is within the location.

2. The method of claim 1, further comprising:
providing, through the music server, a capability to the user to provide access to the song to the another user through the music device when the another music device is within the location.

3. The method of claim 1, comprising providing the capability to tag the song with at least one of a name of the location, a title of the location, a username and a timestamp.

4. The method of claim 1, comprising solely providing the access to the tagged song to the another user based on verifying an identity of the another music device through the music server.

5. The method of claim 1, comprising tagging the song based on a geospatial location detection capability of at least one of the music device and the music server.

6. The method of claim 1, wherein the music server and the music device are communicatively coupled to each other through a computer network.

7. The method of claim 1, wherein the song is stored in a database associated with the music server and available as a stream therefrom.

8. A music server comprising:
a memory; and
a processor communicatively coupled to the memory, the processor being configured to execute instructions to:
provide a capability to a user of a music device to tag a song accessed from a database via the music server,
associate a location of the music device with the song based on the tagging, and
solely provide access to the tagged song to at least one of the user and another user when a corresponding at least one of the music device of the user and another music device associated with the another user is within the location.

9. The music server of claim 8, wherein the processor is configured to execute instructions to provide a capability to the user to provide access to the song to the another user through the music device when the another music device is within the location.

10. The music server of claim 8, wherein the processor is configured to execute instructions to provide the capability to tag the song with at least one of a name of the location, a title of the location, a username and a timestamp.

11. The music server of claim 8, wherein the processor is configured to execute instructions to solely provide access to the tagged song to the another user based on verifying an identity of the another music device.

12. The music server of claim 8, wherein the processor is configured to execute instructions to tag the song based on a geospatial location detection capability of at least one of the music device and the music server.

13. The music server of claim 8, wherein the processor is configured to execute instructions to enable streaming of the song in the database to the music device.

14. A system, comprising:
a music device; and
a music server communicatively coupled to the music device, the music server being configured to:
provide a capability to a user of the music device to tag a song,
associate a location of the music device with the song based on the tagging, and
solely provide access to the tagged song to at least one of the user and another user when a corresponding at least one of the music device of the user and another music device associated with the another user is within the location.

15. The system of claim 14, wherein the music server is further configured to:
provide a capability to the user to provide access to the song to the another user through the music device when the another music device is within the location.

16. The system of claim 14, wherein the music server is configured to provide the capability to tag the song with at least one of a name of the location, a title of the location, a username and a timestamp.

17. The system of claim 14, wherein the music server is configured to solely provide the access to the tagged song to the another user based on verifying an identity of the another music device.

18. The system of claim 14, wherein the music server is configured to tag the song based on a geospatial location detection capability of at least one of the music device and the music server.

19. The system of claim 14, wherein the music server and the music device are communicatively coupled to each other through a computer network.

20. The system of claim 14, further comprising a database associated with the music server to store the song to be tagged.
